(19) United States
(12) Patent Application Publication
(10) Pub. No.: US 2008/0027940 A1
(43) Pub. Date: Jan. 31, 2008

(54) Automatic data classification of files in a repository

(75) Inventors: William P. Canning, Issaquah, WA (US); Darrell J. Cannon, Sammamish, WA (US); David R. Mowers, Issaquah, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/494,064

(22) Filed: Jul. 27, 2006

(51) Int. Cl. G06F 17/30

(52) U.S. Cl. 707/9

(57) ABSTRACT

An operating system automatically classifies a new file by instructing the application that generated the file to modify the file by applying one or more settings for data usage attributes to the file prior to the application saving the file in a folder.

### BACKGROUND

An organization may have digital information that it wishes to protect from unauthorized use. For example, an organization's sensitive and proprietary information may include financial reports, product specifications, customer data, and confidential e-mail messages.

An organization may have implemented a data security policy and procedures that require all digital information to be classified. Data classification is the process of assigning a category and level of sensitivity to data as it is being created, amended, enhanced, stored or transmitted. The classification of the data should then determine the extent to which the data should be processed, controlled or secured and may also be indicative of its value in terms of business assets.

Merely labeling documents in the footer as “internal use only” or “company confidential” is not sufficient. Technical enforcement of the data usage policy is needed to ensure that sensitive and proprietary information is not mishandled. Procedures that place the onus on the users to implement the data classification are prone to failure, especially since non-technical users might not have an idea how to protect data.

More sophisticated tools may be used to enforce a data usage policy, including, for example, access control lists, encryption, and digital rights management.

Access control lists

Access control lists (ACLs) are used in a file system to control access to files and directories with permissions. The permissions may be granted per user or per group of users. Access permissions for a directory are stored as metadata connected to that directory. When a new subfolder is created in a folder, the subfolder automatically inherits the access permissions of the folder. When a file is created in a folder, the file automatically inherits the access permissions of the folder.

Encryption

Some operating systems provide file encryption capabilities. However, these systems typically do not provide any integrity or authentication protection. For example, Encrypting File System (EFS) is a transparent file encryption service provided by the “MICROSOFT®” “WINDOWS SERVER™” 2003 family, where it is implemented in the operating system. In EFS, a directory header has an encryption flag. If the flag is set, then files subsequently created in that directory are automatically created encrypted. If the flag is unset, then files subsequently created in that directory are automatically created unencrypted. However, with EFS, it is possible for unencrypted files to be stored in a directory where the encrypted flag is set.

A protected file is encrypted with a randomly generated File Encryption Key (FEK) using a symmetric encryption algorithm. EFS “wraps” the FEK by encrypting it with the public keys from one or more EFS certificates. For a user to access an encrypted file, they must have the private key that corresponds to one of the public keys used to “wrap” the FEK. Any user that has access to one of the private keys may get access to a file by first decrypting the wrapped FEK with the private key and then decrypting the file with the recovered FEK. This is known as “cryptographic access”. File-system access is controlled through file access control lists (ACLs) as described above. For a user to have full access to a protected file, the ACLs must be set to allow a user to access the file in addition to the user being given cryptographic access.

Other encryption tools are also available, for example, Pretty Good Privacy (PGP), which is now an open standard for cryptographic privacy and authentication.

Digital Rights Management

Digital Rights Management is a mechanism for protecting content using a technology that travels with the content. Various digital rights management solutions are commercially available, including, for example, software from SealedMedia Inc. of Los Gatos, Calif., and LiveCycle Policy Server from Adobe Systems Inc. of San Jose, Calif. “WINDOWS®” Rights Management is a policy enforcement technology used by applications to help safeguard confidential and sensitive digital information from unauthorized use. “MICROSOFT®” “WINDOWS®” Rights Management Services (RMS) for “WINDOWS SERVER™” 2003 works with RMS-enabled applications to provide protection of information through persistent usage policies (also known as usage rights and conditions), which remain with the information, no matter where it goes. RMS persistently protects any binary format of data, so the usage rights remain with the information, even in transport, rather than the rights merely residing on an organization's network.

An RMS-enabled application, for example, “MICROSOFT®” Office Word 2003, enforces the usage rights through its user interface and object model. For example, if the usage rights are such that a particular user is not allowed to copy the file, then the user interface of the application related to the copy functionality is disabled when the user has opened the file with the application. An author of a rights-protected file explicitly defines a set of usage rights and conditions for that file using an RMS-enabled application. The application then encrypts the file with a symmetric key which is then encrypted using the public key of the author's “WINDOWS®” RMS server. The key is then inserted into a publishing license and the publishing license is bound to the file. Only the author's “WINDOWS®” RMS server can issue use licenses to decrypt the file. If an author fails to explicitly define the set of usage rights and conditions, or selects usage rights and conditions inconsistent with the organization's data usage policy, then implementation of the policy suffers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An organization may have a data usage policy that involves the application of data usage attributes to files that are stored in folders of a file repository. A folder may be classified with a data classification. The data classification has previously been associated with default settings for the data usage attributes by an information technology (IT) administrator of the organization. When a user indicates that a new file, generated by an application, is to be saved to a folder, the operating system automatically classifies the new file. This is accomplished by instructing the application to modify the new file prior to saving the file to the folder. The modification involves applying settings for the attributes to the file. For example, the settings applied to the file may be the default settings associated with the data classification of the folder. In another example, the settings applied to the file may be the default settings associated with a different data classification selected by the user. In yet another example, the settings applied to the file may include non-default settings assigned to the folder. In a further example, the settings applied to the file may include non-default settings assigned directly to the file.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is a block diagram of an exemplary system for implementing embodiments of the described technology;

FIG. 2 is an exemplary graphical user interface to classify or reclassify a folder;

FIG. 3 is an entity-relationship diagram of concepts used in an embodiment;

FIG. 4 is a flowchart of an exemplary method to be performed when classifying a file in the embodiment;

FIG. 5 is an exemplary graphical user interface to classify a file in another embodiment;

FIG. 6 is a flowchart of an exemplary method to be performed when classifying a file in the other embodiment;

FIG. 7 is an exemplary graphical user interface to classify or reclassify a folder in a further embodiment;

FIG. 8 is a flowchart of an exemplary method to be performed when classifying or reclassifying a folder in the further embodiment;

FIG. 9 is an entity-relationship diagram of concepts used in the further embodiment;

FIG. 10 is an exemplary graphical user interface to classify a file in the further embodiment; and

FIG. 11 is a flowchart of an exemplary method to be performed when classifying a file in the further embodiment.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments of the described technology. However it will be understood by those of ordinary skill in the art that the embodiments may be practiced without these specific details. In other instances, well-known methods, procedures and components have not been described in detail so as not to obscure the embodiments of the described technology include computer-readable media for carrying or having computer-executable instructions or data structures stored thereon. Such computer-readable media can be any available media that can be accessed by a general-purpose or special-purpose computer. By way of example, and not limitation, such computer-readable media may comprise physical computer-readable media such as RAM, ROM, EEPROM, flash memory or other memory technology, CD-ROM, DVD or other optical disk storage, magnetic disk storage or other magnetic storage devices, or any other medium which can be used to carry or stored desired program code means in the form of computer-executable instructions or data structures and which can be accessed by a general-purpose or special purpose computer.

When information is transferred or provided over a network or another communications connection (hardwired, wireless, optical or any combination thereof) to a computer system, the computer system properly views the connection as a computer-readable medium. Thus, any such connection is properly termed a computer-readable medium. Combinations of the above should also be included within the scope of computer-readable media. Computer-executable instructions comprise, for example, any instructions and data which cause a general-purpose computer system, special-purpose computer system, or special-purpose processing device to perform a certain function or group of functions. The computer-executable instructions may be, for example, binaries, intermediate format instructions such as assembly language, or even source code.

In this document, a “logical communication link” is defined as any communication path that can enable the transport of electronic data between two entities such as computer systems or modules. The actual physical representation of a communication path between two entities may not be important and can change over time. A logical communication link can include portions of a system bus, a local area network (e.g., an Ethernet network), a wide area network, the Internet, combinations thereof, or portions of any other path that may facilitate the transport of electronic data. Logical communication links can include hardwired links, wireless links, or a combination of hardwired links and wireless links. Logical communication links can also include software or hardware modules that condition or format portions of electronic data so as to make them accessible to components that implement the principles of the described technology. Such modules include, for example, proxies, routers, firewalls, switches, or gateways. Logical communication links may also include portions of a virtual network, such as, for example, Virtual Private Network (“VPN”) or a Virtual Local Area Network (“VLAN”).

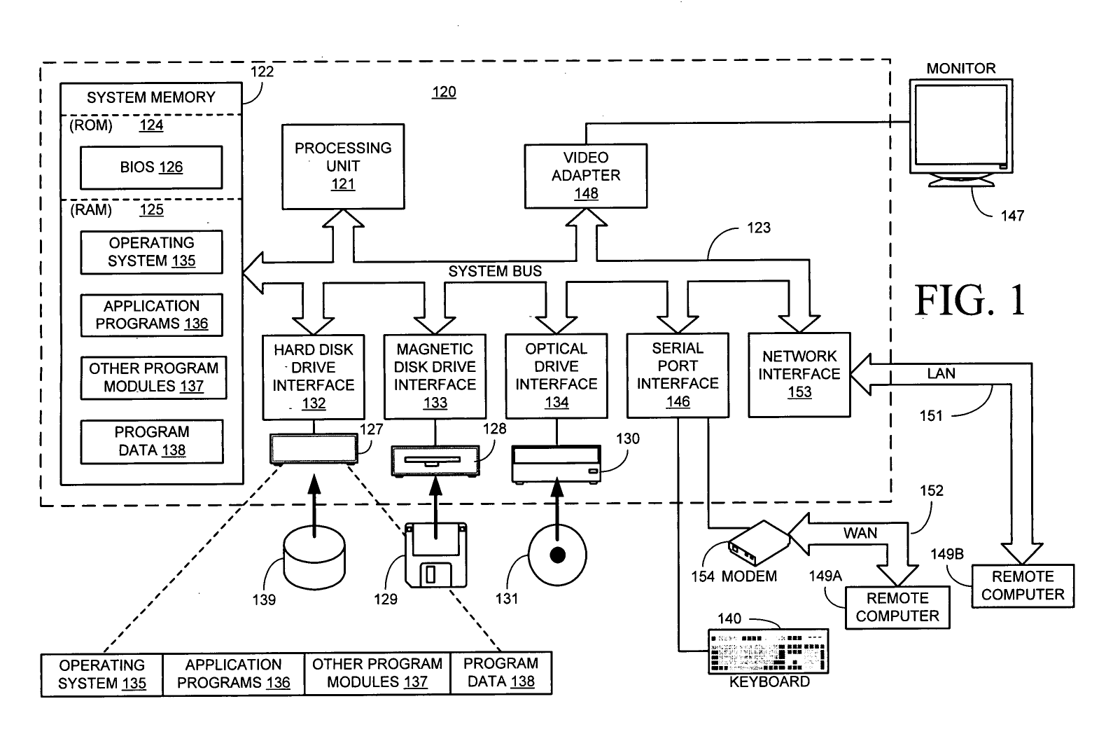

FIG. 1 and the following discussion are intended to provide a brief, general description of a suitable computing environment in which embodiments of the described technology may be implemented. Although not required, some embodiments will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions represents examples of corresponding acts for implementing the functions described in such steps.

With reference to FIG. 1, an exemplary system for implementing embodiments of the described technology comprises a general-purpose computing device in the form of a conventional computer 120, comprising a processing unit 121, a system memory 122, and a system bus 123 that couples various system components including the system memory 122 to the processing unit 121. The system bus 123 may be any of several types of bus structures including a memory bus or memory controller, a peripheral bus, and a local bus using any of a variety of bus architectures. The system memory comprises read only memory (ROM) 124 and random access memory (RAM) 125. A basic input/output system (BIOS) 126, containing the basic routines that help transfer information between elements within the computer 120, such as during start-up, may be stored in ROM 124.

The computer 120 may also comprise a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131 such as a CD-ROM or other optical media. The magnetic hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of computer-executable instructions, data structures, program modules, and other data for the computer 120. Although the exemplary environment described herein employs a magnetic hard disk 139, a removable magnetic disk 129, and a removable optical disk 131, other types of computer readable media for storing data can be used, including magnetic cassettes, flash memory cards, digital video disks, Bernoulli cartridges, RAMs, ROMs, and the like.

Program code means having one or more program modules that may be stored on the hard disk 139, magnetic disk 129, optical disk 131, ROM 124 or RAM 125, comprising an operating system 135, one or more application programs 136, other program modules 137, and program data 138. A user may enter commands and information into the computer 120 through keyboard 140, pointing device 142, or other input devices (not shown), such as a microphone, joy stick, game pad, satellite dish, scanner, or the like. These and other input devices are often connected to the processing unit 121 through a serial port interface 146 coupled to system bus 123. Alternatively, the input devices may be connected by other interfaces, such as a parallel port, a game port, or a universal serial bus (USB). A monitor 147 or another display device is also connected to system bus 123 via an interface, such as video adapter 148. In addition to the monitor, personal computers typically comprise other peripheral output devices (not shown), such as speakers and printers.

The computer 120 may operate in a networked environment using logical communication links to one or more remote computers, such as remote computers 149a and 149b. Remote computers 149a and 149b may each be another personal computer, a client, a server, a router, a switch, a network PC, a peer device or other common network node, and can comprise many or all of the elements described above relative to the computer 120. The logical communication links depicted in FIG. 1 comprise local area network (“LAN”) 151 and wide area network (“WAN”) 152 that are presented here by way of example and not limitation. Such networking environments are commonplace in office-wide or enterprise-wide computer networks, intranets and the Internet.

When used in a LAN networking environment (e.g. an Ethernet network), the computer 120 is connected to LAN 151 through a network interface or adapter 153, which can be a wired or wireless interface. When used in a WAN networking environment, the computer 120 may comprise a wired link, such as, for example, modem 154, a wireless link, or other means for establishing communications over WAN 152. The modem 154, which may be internal or external, is connected to the system bus 123 via the serial port interface 146. In a networked environment, program modules depicted relative to the computer 120, or portions thereof, may be stored in at a remote memory storage device. It will be appreciated that the network connections shown are exemplary and other means of establishing communications over wide area network 152 may be used.

While FIG. 1 illustrates an example of a computer system, any computer system may implement embodiments of the described technology. In the description and in the claims, a “computer system” is defined broadly as any hardware component or components that are capable of using software to perform one or more functions. Examples of computer systems include desktop computers, laptop computers, Personal Digital Assistants (“PDAs”), telephones (both wired and mobile), wireless access points, gateways, firewalls, proxies, routers, switches, hand-held devices, multi-processor systems, microprocessor-based or programmable consumer electronics, network PCs, minicomputers, mainframe computers, embedded computing devices (e.g. computing devices built into a car or ATM (automated teller machine)) or any other system or device that has processing capability.

Those skilled in the art will also appreciate that embodiments may be practiced in network computing environments using virtually any computer system configuration. Embodiments may also be practiced in distributed system environments where local and remote computer systems, which are linked (either by hardwired links, wireless links, or by a combination of hardwired and wireless links) through a network, both perform tasks. In a distributed system environment, program modules may be located in both local and remote memory storage devices.

An organization may have a data usage policy that involves the application of data usage attributes to files that are stored in folders of a file repository. Magnetic hard disks, removable magnetic disks, and removable optical disks are all examples of media where a file repository can exist. A file repository may be remote and accessed through a communication link. A file repository may be a collaborative portal application, such as “Microsoft Office SharePoint Server®”, Documentum eRoom from EMC Corporation of Hopkinton, Mass., or WebOffice from WebEx Communications Inc. of Burlington, Mass. Other types of file repositories are also contemplated.

If the onus is on a user to apply the attributes to a file, implementation of the policy may suffer. To reduce the onus on the user to implement the policy, a folder may be classified with a data classification, and a new file is automatically classified when saved to the folder. The data classification has previously been associated with default settings for the data usage attributes by an information technology (IT) administrator of the organization.

For example, the following data classifications may be used: Public Use, Internal Use Only, Company Confidential, and Department Confidential, listed in order of increasing restrictiveness. This is just an example, and other data classifications are also contemplated.

The data classification Public Use may be applicable to information in the public domain. A non-exhaustive list of examples of files that may be classified as Public Use includes annual reports, press statements, and other information belonging to the organization that has been approved for public use.

The data classification Internal Use Only may be applicable to information that is not approved for general circulation outside the organization, but disclosure of which is unlikely to be seriously damaging to the organization. A non-exhaustive list of examples of files that may be classified as Internal Use Only includes internal memos, minutes of meetings, and internal project reports.

The data classification Company Confidential may be applicable to information that is proprietary to the organization and other confidential information. A non-exhaustive list of examples of files that may be classified as Company Confidential includes customer lists, procedures, project plans, designs and specifications.

The data classification Department Confidential may be applicable to highly sensitive information access to which should be restricted to a single department in the organization. A non-exhaustive list of examples of files that may be classified as Department Confidential includes human resources files, accounting information, and business development plans.

The data usage attributes related to the data classification may include, for example, who can read the data, who can modify the data, who can print the data, who can cut-and-paste the data, whether the data can be forwarded, when the data expires, and whether the data must be encrypted. This is just an example, and other data usage attributes are also contemplated.

The possible values of a data usage attribute may be ordered according to restrictiveness. For example, the data usage attribute “who can read the data” may have the following values (listed from least restrictive to most restrictive): “anyone”, “all internal users”, “all full-time employees”, “file owner's department”, and “file owner”.

An exemplary configuration of data classifications and default settings for the data usage attributes is shown in the following table. This is just an example, and other default settings are also contemplated.

| | Data Classification | | | |
|---|---|---|---|---|
| Data | Public | Internal Use | Company | Department |
| Usage Attribute | Use | Only | Confidential | Confidential |
| Who can read? | anyone | all internal users | all full-time employees | file owner's dept. |
| Who can modify? | no one | file owner | file owner | file owner |
| Who can print? | anyone | all internal users | all full-time employees | file owner's dept. |
| Who can cut-and-paste? | anyone | all internal users | no one | no one |
| Is forwarding permitted? | yes | no | no | no |
| Retention period (from | 3 years | 3 years | 7 years | 7 years |
| creation) | | | | |
| Encryption? | no | no | yes | yes |

In a computing environment where a digital rights management system is available, the IT administrator of the organization may have established rights policy templates. Rather than specifying individual settings for the various data usage attributes for a particular data classification, the IT administrator may associate one or more rights policy templates with the particular data classification.

When a new folder is created, it may inherit its data classification from the folder in which it is created. For example, if a new folder is created in a folder classified as Internal Use Only, then the new folder is automatically classified as Internal Use Only by the operating system when it is created. Alternatively, the new folder may be created with a default data classification or with no data classification at all. Alternatively, a graphical user interface to classify the folder may appear automatically as part of the process of creating a new folder.

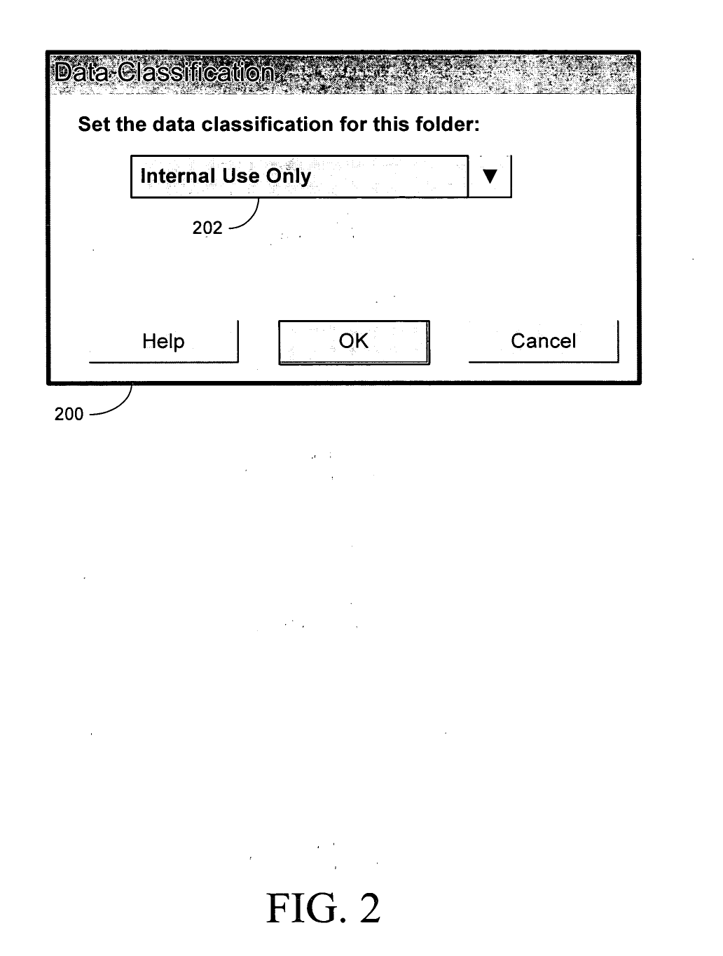

FIG. 2 is an exemplary graphical user interface to classify or reclassify a folder. A dialog box 200 may be provided by the operating system, for example, operating system 135. Dialog box 200 may be accessible in a variety of manners, including, for example, selecting a menu item in a file manager, right-clicking the folder name in a file manager window, or right-clicking an icon for the folder on a desktop. Dialog box 200 may appear automatically as part of the process of creating a new folder. Dialog box 200 includes a drop-down list box 202 that lists data classifications available for selection by the user. By default, drop-down list box 202 may show the data classification of the parent folder containing the folder being classified or reclassified. Alternatively, by default, drop-down list box 202 may show the current data classification of the folder being classified or reclassified. Alternatively, drop-down list box 202 may show a default data classification. The data classifications listed in drop-down list box 202 may be a complete list or may exclude some data classifications, for example, those that are less restrictive than the data classification of the parent folder containing the folder being classified or reclassified. For example, if a folder to be classified or reclassified is contained in a parent folder classified as Internal Use Only, then the data classification Public Use may be excluded and only Internal Use Only, Company Classified and Department Classified may be listed in drop-down list box 202.

In some embodiments, in order to prevent security risks, a folder that is not empty (i.e. the folder contains files) may not be reclassified.

The data classification may be stored as metadata connected to the folder. It may be helpful for users to be informed of the data classification of a folder. For example, in “WINDOWS®” Explorer, a user may choose which details of a selected item are viewable, and the data classification of the selected folder may also be viewable. In another example, the data classification of a folder may be indicated to the user by a special icon, or by color-coding, or any other suitable indication.

The data to be protected according to;the data classification policy is not in the folders, but rather in the files. Hence, the settings of the data usage attributes need to be applied to the files. The embodiments described below enable a new file to be classified automatically prior to being saved in a folder of a file repository.

In a simple embodiment, when a user saves a new file generated by an application to a folder, the file is automatically classified according to the data classification of the folder in which it is saved. No particular input is required on the part of the user. This automatic classification comprises instructing the application to modify the file prior to saving the file to the folder. The modification of the file comprises applying to the file the default settings associated with the data classification of the folder.

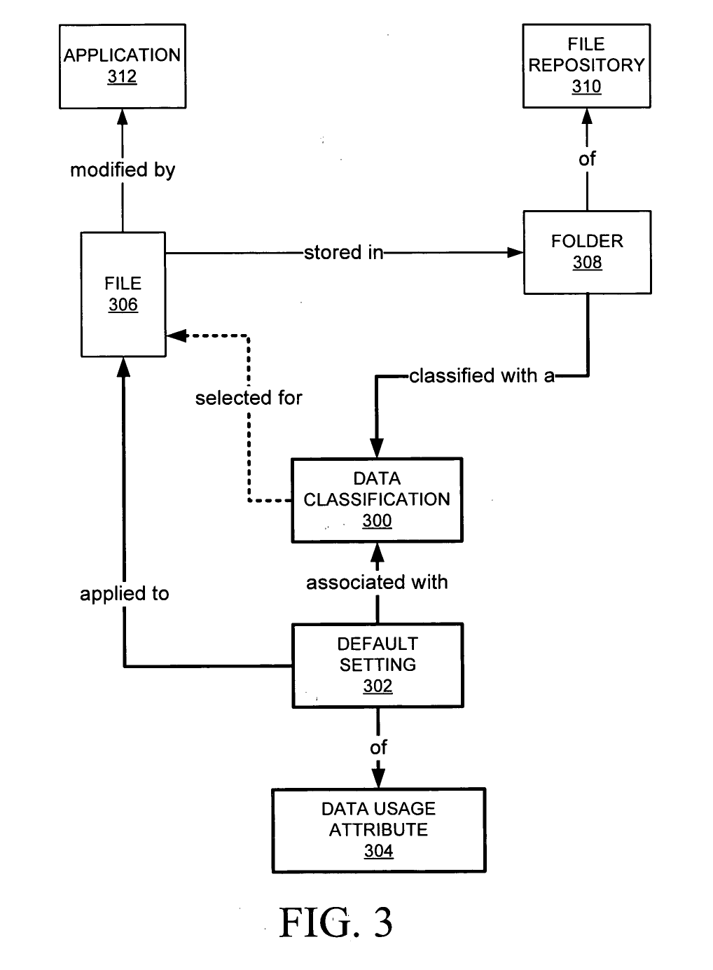

FIG. 3 is an entity-relationship diagram of concepts used in this simple embodiment. Two or more data classifications 300 are defined for use in an organization. Default settings 302 of data usage attributes 304 are associated with each data classification 300. Prior to saving a file 306 in a folder 308 of a file repository 310, an application 312 modifies the file by applying to the file the default settings associated with the data classification of folder 308.

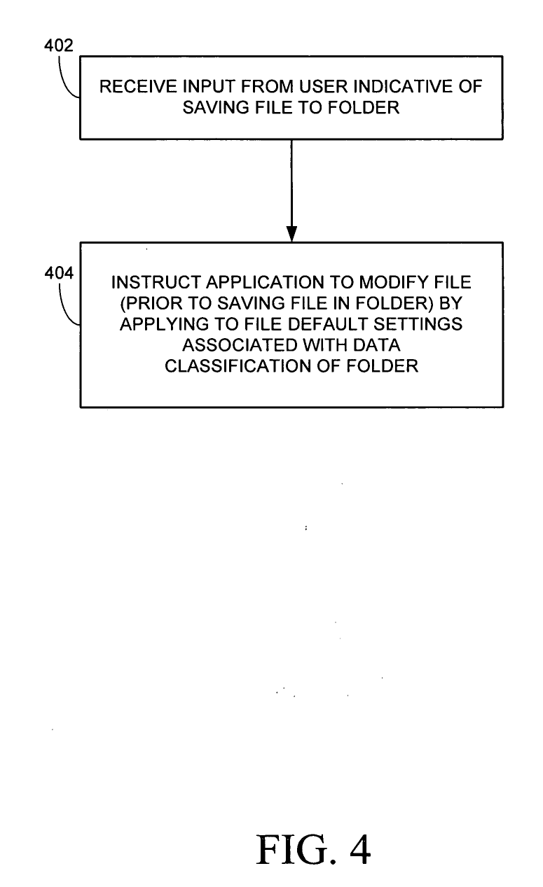

FIG. 4 is a flowchart of an exemplary method to be performed when classifying a file in this simple embodiment. At 402, the operating system receives user input indicative of saving the file to a folder, for example, user input that the user has activated a “Save” button of a standard “File Save” dialog box. At 404, the operating system instructs the application to modify the file by applying to the file the default settings associated with the data classification of the folder.

Precisely how the application applies the settings to the file will depend upon the data usage attributes, the settings and the application. For example, if the application is RMS-enabled and the computing environment is one where “MICROSOFT®” “WINDOWS®” Rights Management is available, the application may perform the appropriate Information Rights Management (IRM) activities on the file. Any encryption required according to the settings, if not handled as part of the IRM activities, will be done to the file after the IRM activities have been performed and before the file is saved to the folder.

In another embodiment, a user may be able to select a different data classification for a file than the data classification of the folder in which the file is to being saved. In some implementations, any data classification may be selected for the file. In other implementations, only a more restrictive data classification than that of the folder in which the file is to be saved may be selected. For example, a user may classify a file as Department Confidential and save it in a folder classified as Company Confidential, but may not save a file classified as Public Use in a folder classified as Company Confidential. In yet other implementations, only a less restrictive data classification than that of the folder in which the file is to be saved may be selected.

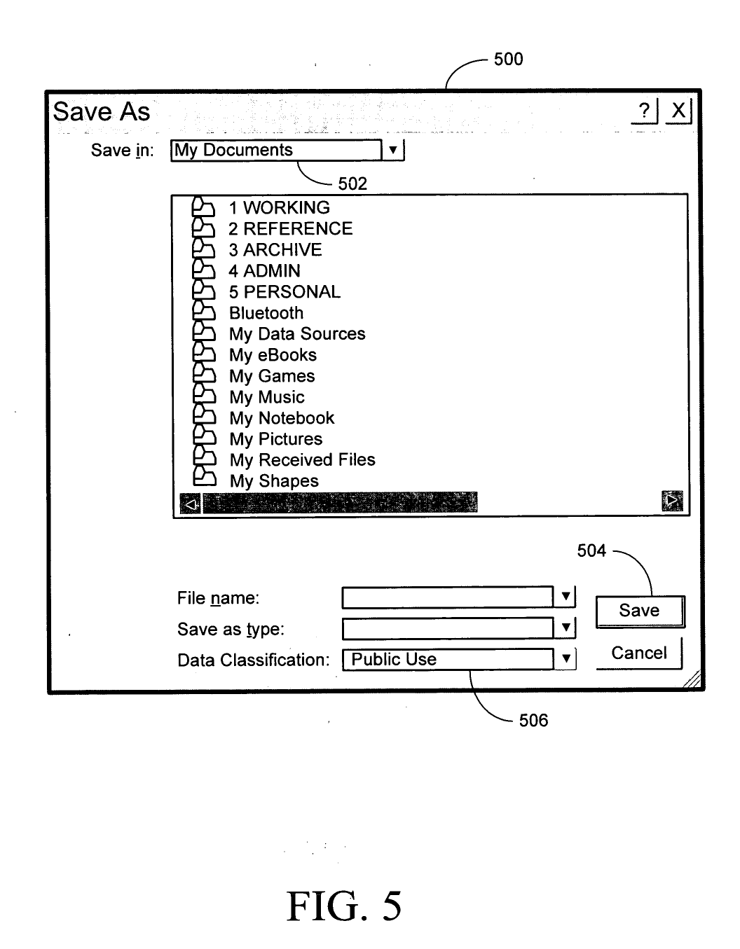

FIG. 5 is an exemplary graphical user interface to classify a file. A “save as” dialog box 500 may be provided by the operating system when a user attempts to save a new file from within an application. Dialog box 500 includes a combination drop-down list box 502 that indicates to which folder the file will be saved if the user activates a “Save” button 504. Dialog box 500 also includes a drop-down list box 506 that lists data classifications available for selection by the user. By default, drop-down list box 506 may show the data classification of the folder indicated in combination list box 502. Alternatively, by default, drop-down list box 506 may show a default data classification. The data classifications listed in drop-down list box 506 may be a complete list or may exclude some data classifications, for example, those that are less restrictive than the data classification of the folder indicated in combination list box 502.

In the example shown in FIG. 5, the folder “My Documents” is classified as Public Use, and drop-down list box 506 shows the data classification Public Use by default. If the user activates “Save” button 504, the application will apply to the file the settings assigned to the folder “My Documents”. If the user first chooses Company Confidential from drop-down list box 506 and then activates “Save” button 504, the application will apply the default settings associated with the data classification Company Confidential to the file, prior to saving the file to the folder “My Documents”.

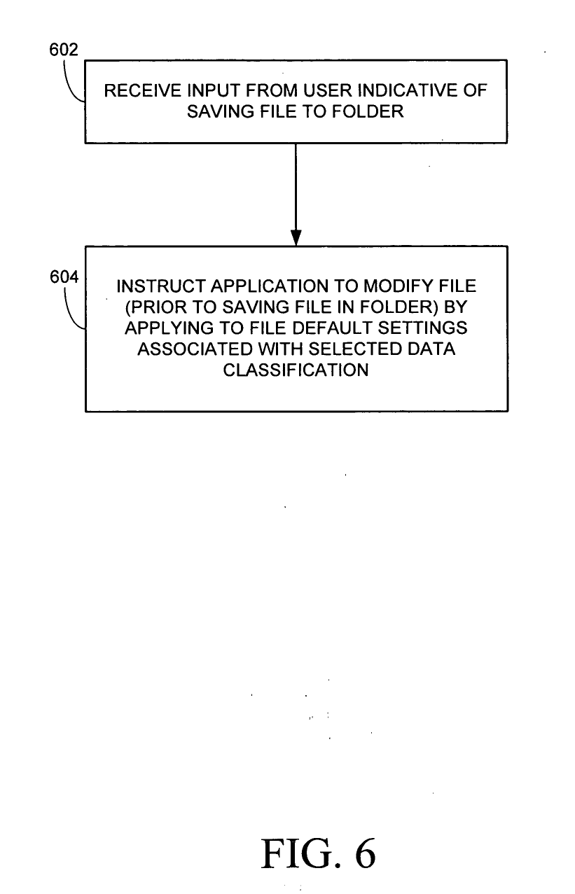

FIG. 6 is a flowchart of an exemplary method to be performed when classifying a file in this embodiment. At 602, the operating system receives user input indicative of saving the file to a folder, for example, user input that the user has activated “Save” button 504 of dialog box 500. At 604, the operating system instructs the application to modify the file by applying to the file the default settings associated with the data classification selected for the file (for example, as indicated in drop-down list box 506). As before, precisely how the application applies the settings to the file will depend upon the data usage attributes, the settings and the application.

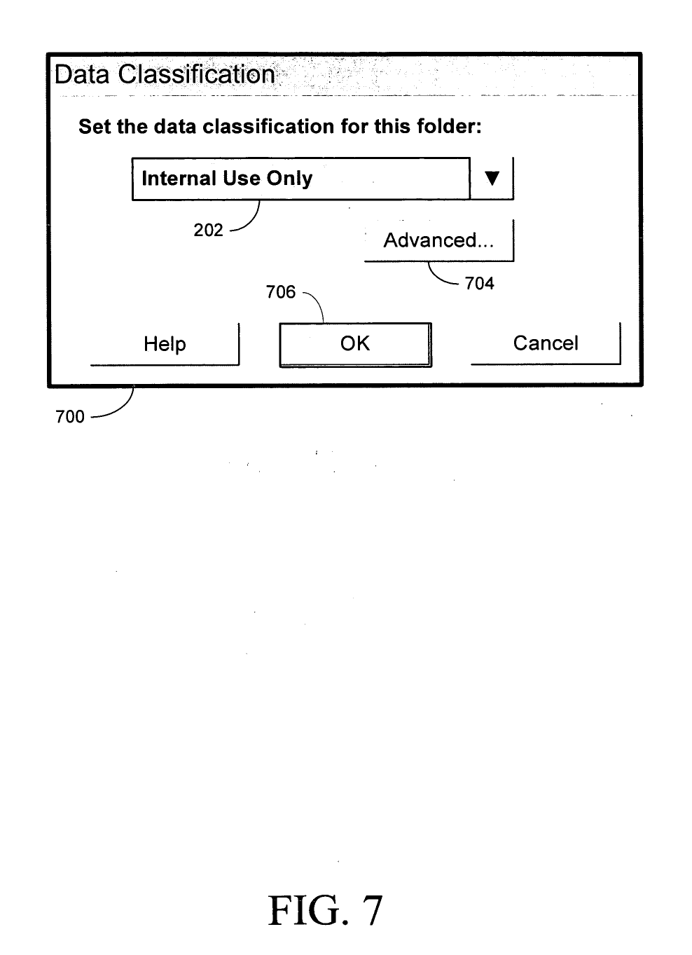

In yet another embodiment, non-default settings for the data usage attributes may be assigned by the user to a folder and/or to a file. FIG. 7 is an exemplary graphical user interface to classify or reclassify a folder. A dialog box 700 may be provided by the operating system, for example, operating system 135. Dialog box 700 is similar to dialog box 200 described above with respect to FIG. 2, and that description is applicable to dialog box 700.

Dialog box 700 includes an “Advanced . . . ” button 704 which, if activated by the user, enables the user to assign non-default settings for the data usage attributes to the folder. In alternative implementations, the graphical user interface to classify or reclassify a folder includes an “Advanced . . . ” tab (not shown) or any other suitable interface to enable the user to assign non-default settings for the data usage attributes to the folder.

In some implementations, any non-default setting for the folder is permissible. In other implementations, any non-default setting assigned by the user must be more restrictive than the corresponding default setting of the data classification of the folder.

If a folder is assigned non-default settings of data usage attributes other than the default settings of the data classification of the folder, then the non-default settings or an indication thereof, may be stored as metadata connected to the folder. If a new folder, when created, inherits the data classification of the folder in which it is created, and the folder in which it is created has non-default settings, then the new folder may inherit the settings of the folder in which it is created, including any non-default settings. Alternatively, the new folder may inherit only the data classification of the folder in which it is created (and the default settings associated with the data classification).

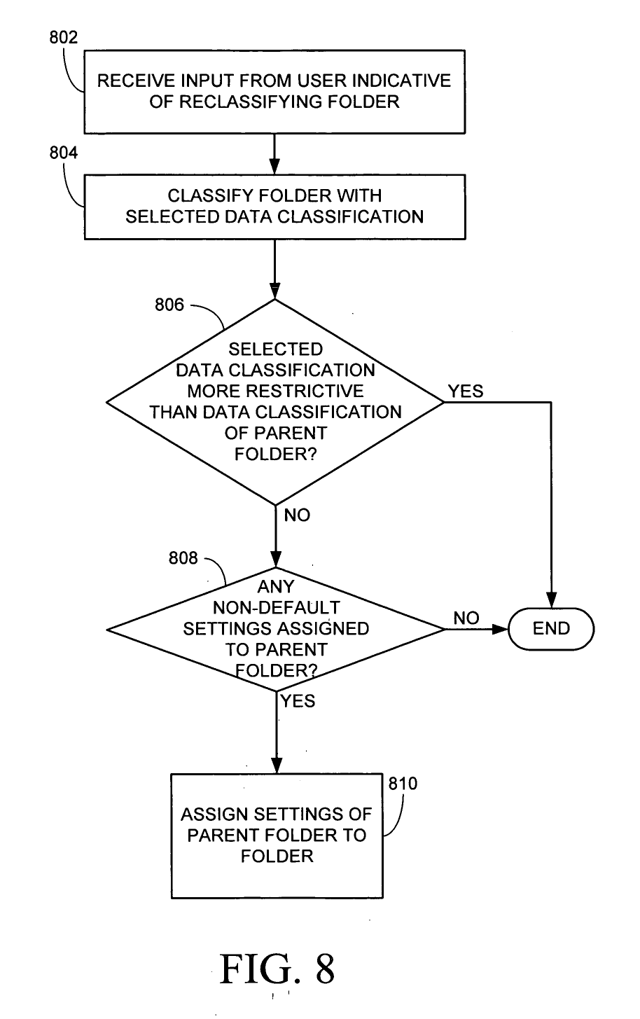

FIG. 8 is a flowchart of an exemplary method to be performed when classifying or reclassifying a folder. At 802, the operating system receives user input indicative of reclassifying a folder, for example, user input that the user has activated an “Okay” button 706 of dialog box 700. At 804, the operating system classifies the folder with the selected data classification. For example, if the user has selected Internal Use Only, then the folder is classified with the data classification Internal Use Only. At 806, the operating system checks whether the selected data classification is more restrictive than the data classification of the parent folder of the folder being reclassified. If not, then at 808, the operating system checks whether any non-default settings are assigned to the parent folder. If so, then at 810 the operating system assigns the settings of the parent folder to the folder being reclassified.

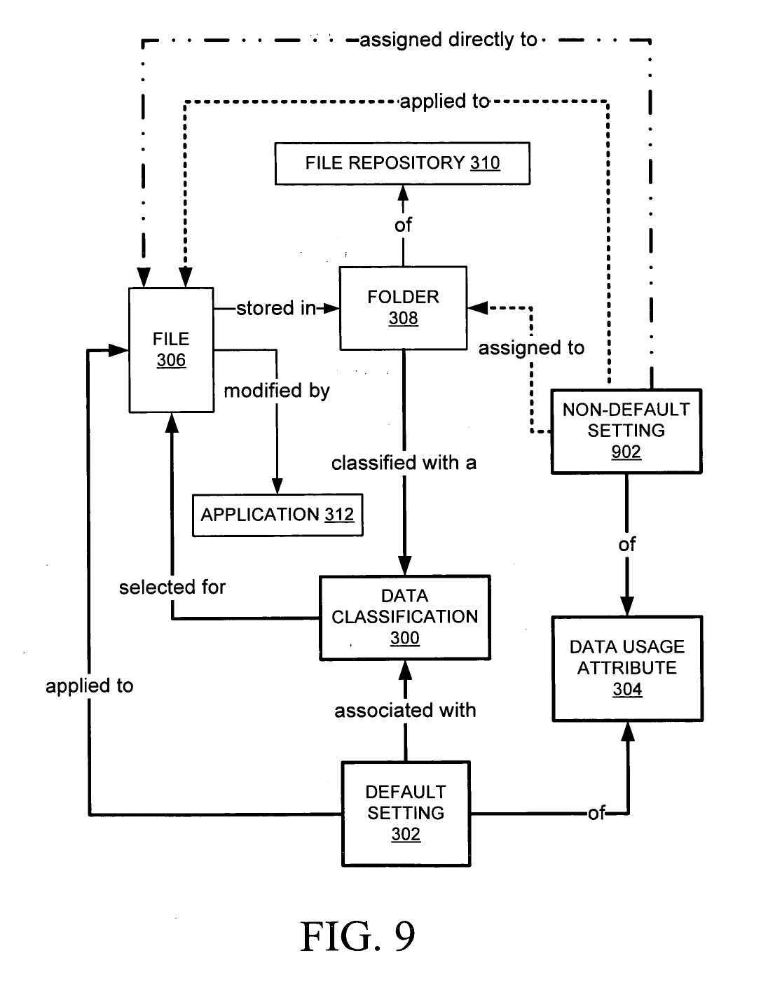

FIG. 9 is an entity-relationship diagram of concepts used in the embodiment where non-default settings are permitted. The diagram of FIG. 9 differs from that of FIG. 3 in that a non-default setting 902 of data usage attribute 304 may be assigned to folder 308 or assigned directly to file 306. In either case, the non-default setting is applied to file 306 prior to saving file 306 in folder 308.

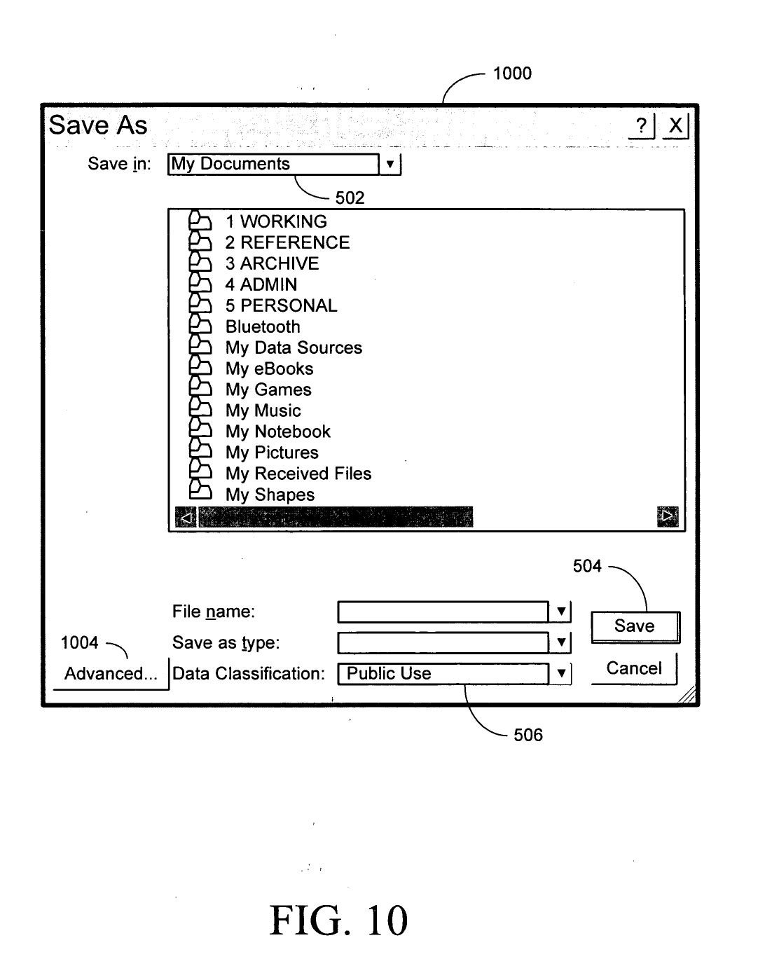

FIG. 10 is an exemplary graphical user interface to classify a file. A “save as” dialog box 1000 may be provided by the operating system when a user attempts to save a new file from within an application. Dialog box 1000 is similar to dialog box 500 described above with respect to FIG. 5, and that description is applicable to dialog box 1000.

Dialog box 1000 includes an “Advanced . . . ” button 1004 which, if activated by the user, enables the user to assign non-default settings for the data usage attributes to the file. In alternative implementations, the graphical user interface to classify a file includes an “Advanced . . . ” tab (not shown) or any other suitable interface to enable the user to assign non-default settings for the data usage attributes to the file.

In some implementations, any non-default setting for the file is permissible. In other implementations, any non-default setting assigned by the user to the file must be more restrictive than the corresponding setting (default or otherwise) of the folder.

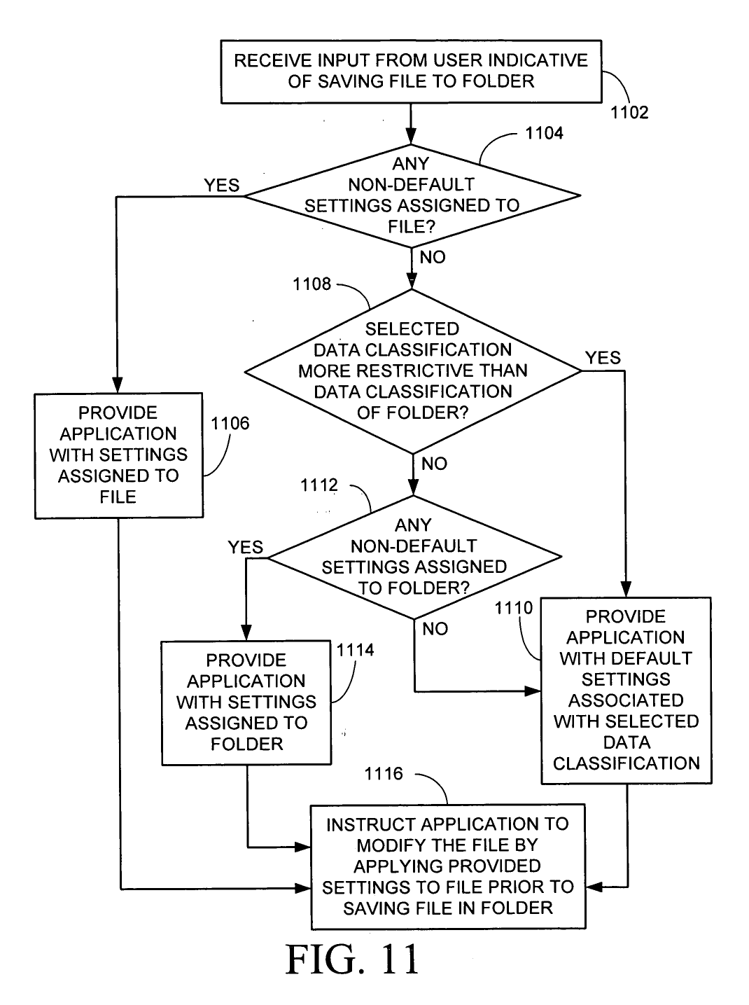

FIG. 11 is a flowchart of an exemplary method to be performed when classifying a file. At 1102, the operating system receives user input indicative of saving the file to a folder, for example, user input that the user has activated “Save” button 504 of dialog box 1000. At 1104, the operating system checks whether any non-default settings of data usage attributes have been selected for the file. If so, then the operating system provides the selected settings (default and non-default) to the application at 1106. If not, then at 1108, the operating system checks whether the selected data classification, for example, the data classification shown in drop-down list box 506, is more restrictive than the data classification of the folder. If so, then at 1110, the operating system provides the application that generated the file with the default settings associated with the selected data classification. If the selected data classification is not more restrictive than the data classification of the folder, then at 1112, the operating system checks whether any non-default settings are assigned to the folder. If not, then the method continues to 11 10, where the default settings associated with the selected data classification are provided to the application. However, if one or more non-default settings are assigned to the folder, then at 1114 the operating system provides the settings assigned to the folder to the application. From 1106, 1110 and 1114, the method continues to 1116, where the operating system instructs the application to apply the provided settings to the file prior to saving the file in the folder.

As before, precisely how the application applies the settings to the file will depend upon the data usage attributes, the settings and the application.

The automatic classification of files and folders as described above may be complemented by the use of access control lists implemented in the operating system and/or file repository as is known in the art.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
automatically classifying a new file by instructing an application to modify the file by applying one or more settings for data usage attributes to the file prior to saving the file in a folder.

2. The method of claim 1, further comprising:
classifying the folder with a data classification that is one of two or more data classifications each having associated therewith one or more default settings for the attributes.

3. The method of claim 2, wherein the settings applied to the file are identical to the default settings associated with the data classification of the folder.

4. The method of claim 2, further comprising:
enabling a user to select for the file a more restrictive data classification than the data classification of the folder,
wherein the settings applied to the file are the default settings associated with the more restrictive data classification.

5. The method of claim 2, further comprising:
upon creation of a subfolder of the folder, automatically classifying the subfolder with the data classification of the folder.

6. The method of claim 5, further comprising:
enabling a user to reclassify the subfolder with a more restrictive data classification than the data classification of the folder.

7. The method of claim 1, further comprising:
assigning one or more settings for the data usage attributes to the folder.

8. The method of claim 7, wherein the settings applied to the file are the settings assigned to the folder.

9. The method of claim 7, further comprising:
classifying the folder with a data classification that is one of two or more data classifications each having one or more default settings for the data usage attributes associated therewith,
wherein at least one of the settings assigned to the folder is more restrictive than its corresponding default setting associated with the data classification of the folder.

10. The method of claim 7, further comprising:
upon creation of a subfolder of the folder, assigning to the subfolder the settings assigned to the folder.

11. The method of claim 1, wherein instructing the application to apply the settings to the file comprises:
instructing the application to apply a rights management template to the file.

12. The method of claim 1, wherein instructing the application to apply the settings to the file comprises:
instructing the application to encrypt the file.

13. A graphical user interface for saving a file to a folder, the graphical user interface comprising:
a file save dialog box having a data classification selector,
wherein the data classification selector is able to display an initial data classification value and able to display, in response to user input, selectable data classification values including the initial data classification value, whereupon selection of one of the data classification values causes the selected data classification value to be displayed in place of the initial data classification value.

14. The graphical user interface of claim 13, wherein the initial data classification value is a data classification of the folder.

15. The graphical user interface of claim 14, wherein the selectable data classification values include the data classification of the folder and more restrictive data classifications.

16. The graphical user interface of claim 13, wherein the data classification selector is a drop-down list box.

17. A graphical user interface for classifying a folder, the graphical user interface comprising:
a dialog box having a data classification selector,
wherein the data classification selector is able to display an initial data classification value and able to display, in response to user input, selectable data classification values including the initial data classification value, whereupon selection of one of the data classification values causes the selected data classification value to be displayed in place of the initial data classification value.

18. The graphical user interface of claim 17, wherein the initial data classification value is a data classification of another folder which contains the folder to be classified.

19. The graphical user interface of claim 18, wherein the selectable data classification values include the data classification of the other folder and more restrictive data classifications.

20. The graphical user interface of claim 17, wherein the data classification selector is a drop-down list box.
